(19) United States
(12) Patent Application Publication
(10) Pub. No.: US 2023/0133289 A1
(43) Pub. Date: May 4, 2023

(54) POWER CONTROL DEVICE, ELECTRIC MOTOR INCLUDING POWER CONTROL DEVICE, AND AIR-CONDITIONING APPARATUS INCLUDING ELECTRIC MOTOR

(71) Applicant: Mitsubishi Electric Corporation, Tokyo (JP)

(72) Inventors: Junichiro OYA, Tokyo (JP); Mineo YAMAMOTO, Tokyo (JP); Hiroyuki ISHII, Tokyo (JP); Hiroki ASO, Tokyo (JP)

(21) Appl. No.: 17/915,560

(22) PCT Filed: Jun. 16, 2020
(86) PCT No.: PCT/JP2020/023636

§ 371 Date: Sep. 29, 2022

(51) Int. Cl. H02K 11/33

(52) U.S. Cl. CPC H02K 11/33; H02K 2211/03; F24F 13/00

(57) ABSTRACT

Provided is a power control device that drives an electric motor including a rotor into which a rotary shaft is inserted and a stator, the stator being provided on an outer peripheral side of the rotor, the power control device including: a substrate having a through hole and disposed to face the rotor and the stator, the rotary shaft being caused to pass through the through hole; a power semiconductor module mounted on the substrate and including a drive circuit; and a microcomputer mounted on the substrate, and configured to control power supplied to the electric motor, wherein the substrate is integrally formed with the stator by using a molded resin, and a first part having a lower thermal conductivity than the molded resin is disposed on the substrate at a position between the power semiconductor module and the microcomputer.

### TECHNICAL FIELD

The present disclosure relates to a power control device that controls power supply, to an electric motor including the power control device, and to an air-conditioning apparatus including the electric motor.

### BACKGROUND ART

Conventionally, an electric motor includes a power control device that controls driving of a motor body including a rotor, a stator, and other components. The power control device includes a substrate on which a power transistor, a microcomputer, and other components are mounted. For the substrate, for example, an annular substrate is adopted that has a through hole through which a rotary shaft of the rotor, and the like is caused to pass (see Patent Literature 1, for example).

### CITATION LIST

### Patent Literature

Patent Literature 1: Japanese Unexamined Patent Application Publication No. 2015-171200

### SUMMARY OF INVENTION

### Technical Problem

In a conventional technique disclosed in Patent Literature 1, heat from heat generating parts, such as a power transistor, is transferred to a microcomputer, thus causing the temperature of the microcomputer to rise to a temperature equal to or higher than the operation guarantee temperature. Particularly in the case where a substrate and a stator are integrally molded by using a resin, heat from the heat generating parts is easily transferred to the microcomputer via the resin and hence, the temperature of the microcomputer significantly rises. As a result, there is the problem that it is difficult to achieve a high output and a reduction in size of an electric motor.

The present disclosure has been made to solve the above-mentioned problem, and it is an object of the present disclosure to provide a power control device that can suppress a rise in temperature of the microcomputer, to provide an electric motor including the power control device, and to provide an air-conditioning apparatus including the electric motor.

### Solution to Problem

A power control device according to one embodiment of the present disclosure is a power control device that drives an electric motor including a rotor into which a rotary shaft is inserted and a stator; the stator being provided on an outer peripheral side of the rotor, the power control device including: a substrate having a through hole and disposed to face the rotor and the stator, the rotary shaft being caused to pass through the through hole; a power semiconductor module mounted on the substrate and including a drive circuit; and a microcomputer mounted on the substrate, and configured to control power supplied to the electric motor, wherein the substrate is integrally formed with the stator by using a molded resin, and a first part having a lower thermal conductivity than the molded resin is disposed on the substrate at a position between the power semiconductor module and the microcomputer.

An electric motor according to another embodiment of the present disclosure is an electric motor including: the rotor into which a rotary shaft is inserted; the stator provided on an outer peripheral side of the rotor; and the above-mentioned power control device.

An air-conditioning apparatus according to still another embodiment of the present disclosure is an air-conditioning apparatus including: an indoor unit; and an outdoor unit, wherein at least one of the indoor unit and the outdoor unit includes a fan, and the above-mentioned electric motor is provided as a power source for the fan.

### Advantageous Effects of Invention

In the power control device according to one embodiment of the present disclosure, the first part having a lower thermal conductivity than the molded resin is disposed on the substrate at a position between the power semiconductor module and the microcomputer. Therefore, a low thermal conductivity is achieved between the power semiconductor module and the microcomputer, so that heat from the power semiconductor module is prevented from being easily transferred to the microcomputer and hence, it is possible to suppress a rise in temperature of the microcomputer. As a result, it is possible to achieve a higher output and a further reduction in size of the electric motor including the power control device.

### BRIEF DESCRIPTION OF DRAWINGS

FIG. 1 is a schematic cross-sectional view showing a configuration of an electric motor according to Embodiment 1.

FIG. 2 is a circuit diagram showing a constitutional example of a circuit of a power control device included in the electric motor according to Embodiment 1.

FIG. 3 is a schematic view showing a schematic configuration of a substrate of the power control device included in the electric motor according to Embodiment 1 as viewed from an opposite stator side.

FIG. 4 is a first schematic view showing a schematic configuration of a substrate of a power control device included in a conventional electric motor as viewed from an opposite stator side.

FIG. 5 is a schematic view showing a schematic configuration of a first modification of the substrate of the power control device included in the electric motor according to Embodiment 1 as viewed from the opposite stator side.

FIG. 6 is a schematic view showing a schematic configuration of a second modification of the substrate of the power control device included in the electric motor according to Embodiment 1 as viewed from the opposite stator side.

FIG. 7 is a schematic view showing a cross section of a schematic configuration of the electric motor according to Embodiment 1,

FIG. 8 is a second schematic view showing the schematic configuration of the substrate of the power control device included in the electric motor according to Embodiment 1 as viewed from the opposite stator side.

FIG. 9 is a schematic view showing a cross section of a schematic configuration of a first modification of the electric motor according to Embodiment 1.

FIG. 10 is a schematic view showing a cross section of a schematic configuration of a second modification of the electric motor according to Embodiment 1.

FIG. 11 is a schematic view showing a constitutional example of an air-conditioning apparatus according to Embodiment 2.

### DESCRIPTION OF EMBODIMENTS

Hereinafter, Embodiments of the present disclosure will be described with reference to drawings. The present disclosure is not limited by Embodiments described below. In addition, the relationship of sizes of respective components in the following drawings may differ from that of the actual ones.

### Embodiment 1

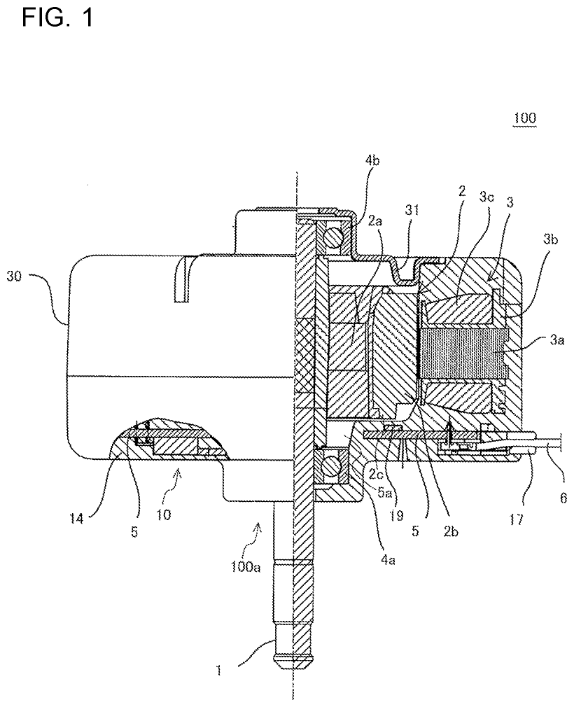

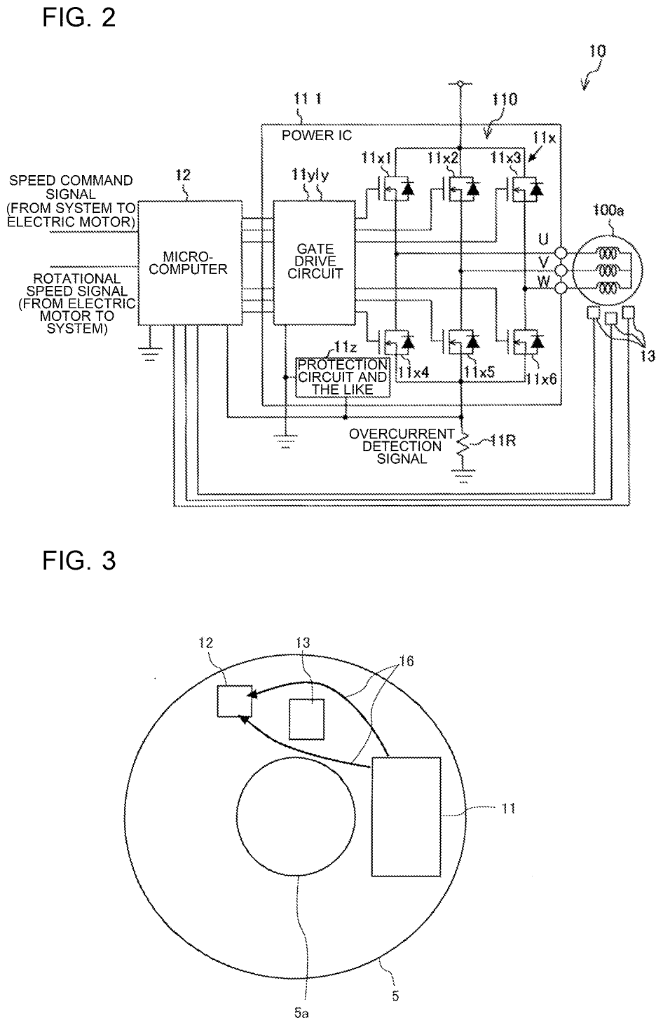

FIG. 1 is a schematic cross-sectional view showing a configuration of an electric motor 100 according to Embodiment 1. FIG. 2 is a circuit diagram showing a constitutional example of a circuit of a power control device 10 included in the electric motor 100 according to Embodiment 1.

The electric motor 100 may be, for example, a brushless DC motor that is driven by an inverter. The electric motor 100 outputs power to a load connected to a rotary shaft 1, which will be described later. As shown in FIG. 1, the electric motor 100 includes a motor body 100a and the power control device 10 that generates power for driving the motor body 100a in response to a speed command signal transmitted from a higher-level system of the electric motor 100. In Embodiment 1, the higher-level system of the electric motor 100 means a control board of equipment that incorporates the electric motor 100. For example, in the case where the electric motor 100 is incorporated in an air conditioner, a control board in an air conditioner unit corresponds to the higher-level system of the electric motor 100.

The motor body 100a includes the rotary shaft 1, a rotor 2, an annular stator and an output-side bearing 4a and an opposite-output-side bearing 4b, the rotary shaft 1 being inserted into the rotor 2, the stator 3 being provided on the outer peripheral side of the rotor 2, the output-side bearing 4a and the opposite-output-side bearing 4b rotatably supporting the rotary shaft 1. The output-side bearing 4a is provided at one end of the rotary shaft 1, and rotatably supports the rotary shaft 1 at the one end of the rotary shaft 1. The opposite-output-side bearing 4b is provided at the other end of the rotary shaft 1, and rotatably supports the rotary shaft 1 at the other end of the rotary shaft 1.

The power control device 10 includes a substrate 5 disposed on the output side of the stator 3. The substrate 5 includes a circuit that includes a power semiconductor module 11, a microcomputer 12 (see FIG. 2, which will be described later), and a magnetic sensor 19, such as a Hall IC, that detects the position of the rotor 2. The substrate 5 is disposed to be perpendicular to the axial direction of the rotary shaft 1 at a position between the stator 3 and the output-side bearing 4a, and is fixed to an insulator 3b, which will be described later. Further, the stator 3 and the substrate 5 are integrally formed by using a molded resin 14 that forms a housing, thus forming a molded stator 30 in which the molded resin 14 forms an outer shell. In Embodiment 1, the molded resin 14 is formed by mixing a thermosetting resin, such as epoxy, with silica filler in a ratio of 10 to 20% of the thermosetting resin to 80 to 90% of silica filler, for example.

The molded stator 30 is obtained by integrally molding the stator 3 and the substrate 5, and has a recessed portion (not shown in the drawing) formed such that the rotor 2 can be accommodated in the recessed portion. A conductive bracket 31 is fitted in an inner peripheral portion of the molded stator 30 to close an opening port of the recessed portion of the molded stator 30, and an outer race of the opposite-output-side bearing 4b is fitted in the inside of the conductive bracket 31. The substrate 5 has a through hole 5a through which the rotary shaft 1 and the output-side bearing 4a are caused to pass. That is, the substrate 5 is formed into an annular shape, and is disposed to face the rotor 2 and the stator 3. The power semiconductor module 11 of the substrate 5 is connected with a winding 3c, which will be described later, via a winding terminal.

The rotor 2 is made of a resin, for example, and includes a rotor body 2a, a rotor magnet 2b, and a sensor magnet 2c, the rotor body 2a being provided on the outer peripheral side of the rotary shaft 1, the rotor magnet 2b being disposed on the inner side of the molded stator 30 and being made of a permanent magnet disposed to face a stator core 3a, which will be described later, the sensor magnet 2c being disposed at the end portion of the rotor magnet 2b on the substrate 5 side to face the magnetic sensor 19. The rotor body 2a provides insulation between the rotary shaft 1 and the rotor magnet 2b, and also provides insulation between the rotary shaft 1 and the stator core 3a. The rotor magnet 2b is formed by injection molding bond magnet obtained by mixing ferrite magnet or rare earth magnet with a thermoplastic resin material. Magnets are incorporated in a mold for injection molding, and injection molding is performed while an orientation is applied. To dispose the sensor magnet 2c in the vicinity of the magnetic sensor 19 on the substrate 5, the sensor magnet 2c is disposed at a predetermined position on the rotor 2 by using the rotary shaft 1 as the center of a circle.

In the stator 3, the outer diameter of the sensor magnet 2c is smaller than the outer diameter of the rotor magnet 2b, so that magnetic flux easily flows into the magnetic sensor 19 mounted on the substrate 5. To reduce an influence of magnetic flux generated from the winding 3c of the stator 3 as much as possible, the magnetic sensor 19 is disposed at a position away from the winding 3c, that is, at a position close to the rotary shaft 1. In FIG. 1, the rotor magnet 2b and the sensor magnet 2c are formed from one magnet. However, the rotor magnet 2b and the sensor magnet 2c may be respectively formed from different magnets.

The stator 3 includes the stator core 3a, the insulator 3b, and the winding 3c. The stator core 3a is formed by laminating a plurality of electromagnetic steel sheets. The insulator 3b is provided for providing insulation between the stator core 3a and the winding 3c, and is integrally molded with the stator core 3a. The winding 3c is wound around each slot of the stator core 3a with which the insulator 3b is integrally molded.

A lead-out portion 17 including a lead wire 6 is disposed on the substrate 5, the lead wire 6 being connected with the higher-level system, Passive components, such as an operational amplifier, a comparator, a regulator, a diode, a resistor, a capacitor, and a fuse, are disposed on the substrate 5,

As shown in FIG. 2, the power semiconductor module 11 includes a drive circuit 110 that includes six power transistors 11x (11x1 to 11x6) each of which is a switching element, such as an insulated gate bipolar transistor (IGBT). The drive circuit 110 is an inverter circuit that converts a voltage inputted from the outside to a three-phase AC voltage by the operation of each power transistor 11x, and supplies the three-phase AC voltage to the motor body 100a. The power semiconductor module 11 also includes circuits, such as a gate drive circuit 11y and a protection circuit 11z.

The power semiconductor module 11 is also referred to as “intelligent power module (IPM)”. There may be a case where six power transistors 11x are individually formed. In such a case, the gate drive circuit 11y may be formed from one IC or may be formed from three ICs for three different phases.

There may also be a case where the gate drive circuit 11y and the microcomputer 12 are formed from one IC. Each power transistor 11x may be a superjunction MOSFET, a planar MOSFET, an IGBT, or other transistors. The microcomputer 12 controls power supplied to the electric motor 100. For the microcomputer 12, for example, it is possible to adopt a microcomputer in which a flash memory being a nonvolatile memory is incorporated.

The electric motor 100 being a brushless DC motor obtains rotational power by switching the six power transistors 11x in the power semiconductor module 11 at an appropriate timing according to the position of the magnetic pole of the rotor magnet 2b. The microcomputer 12 generates and outputs switching signals for turning on or off the six power transistors 11x.

The principle of the operation of the electric motor 100 will be described below.

First, the magnetic sensor 19 outputs a magnetic pole position detection signal indicating the position of the magnetic pole of the rotor magnet 2b to the microcomputer 12, and the magnetic pole position detection signal is inputted into the microcomputer 12. Next, the microcomputer 12 infers the position of the magnetic pole of the rotor 2 from the magnetic pole position detection signal inputted from the magnetic sensor 19. Then, the microcomputer 12 generates a switching signal corresponding to the inferred position of the magnetic pole of the rotor 2 and a speed command signal outputted from the higher-level system, and outputs the switching signal to the power semiconductor module 11.

The microcomputer 12 monitors voltages at both ends of an overcurrent detecting resistor 11R. When the voltages at both ends of the overcurrent detecting resistor 11R reach a voltage equal to or higher than a set voltage, the microcomputer 12 forcibly turns off the power transistors 11x, thus achieving overcurrent protection. When the microcomputer 12 receives an overcurrent detection signal from a temperature sensing element (not shown in the drawing), the microcomputer 12 forcibly turns off the power transistors 11x, thus achieving superheat protection.

As described above, the power control device 10 uses the microcomputer 12 instead of a dedicated IC for controlling power and hence, it is possible to control the motor with a high accuracy due to fine adjustment of control parameters and a complex control algorithm.

In the case where the power control device 10 includes the microcomputer 12 that incorporates a flash memory and where the power control device 10 has a flash rewriting function that can rewrite data in the flash memory after the electric motor 100 is completed, it is possible to correct various amounts of deviation after the electric motor 100 is completed. In this case, the microcomputer 12 is provided with a dedicated lead wire used for communicating signals for rewriting data in the flash memory, and data in the flash memory are rewritten via the dedicated lead wire by I2C communication, for example.

Examples of the amount of deviation that can be corrected after the electric motor 100 is completed include an amount of phase deviation between the position of the magnetic pole and a magnetic pole position detection signal and an amount of deviation from a design value, such as an overcurrent limit value. That is, the power control device 10 having the flash rewriting function can control the motor after measuring the above-mentioned various amounts of deviation and writing parameters based on which the amount of deviation is corrected in the flash memory. Therefore, the power control device 10 can suppress variation in phase deviation between the position of a magnetic pole and a magnetic pole position detection signal, in overcurrent limit values, and the like.

There are two types of magnetic sensor 19, that is, a magnetic sensor 19 that outputs digital signals (hereinafter referred to as “Hall IC”) and a magnetic sensor 19 that outputs analog signals (hereinafter referred to as “Hall element”). There are two types of Hall IC, that is, a Hall IC where a sensor unit and an amplification unit are formed from different semiconductor chips, the sensor unit is made of a semiconductor other than silicon, and the amplification unit is made of silicon (hereinafter referred to as “non-silicon Hall IC”), and a Hall IC where the sensor unit and the amplification unit are formed from one silicon semiconductor chip.

The non-silicon Hall IC incorporates two chips and hence, the center of the sensor is disposed at a position different from the center of an IC body. A semiconductor, such as indium antimonide (InSb), is used for the sensor unit of the non-silicon Hall IC. The non-silicon semiconductor has the advantage that sensitivity is improved and an offset caused by stress distortion is smaller compared with a silicon semiconductor, for example.

The microcomputer 12 or the gate drive circuit 11y incorporates an overcurrent detection unit (not shown in the drawing). The overcurrent detection unit monitors the voltage of an overcurrent detection resistor. When the voltage of the overcurrent detection resistor reaches a voltage equal to or higher than a fixed voltage, the overcurrent detection unit turns off the power transistors 11x, thus achieving overcurrent protection.

The brushless DC motor obtains rotational power by switching the six (in the case of three phases) power transistors 11x in the power semiconductor module 11 at an appropriate timing according to the position of the magnetic pole of the rotor magnet 2b. The microcomputer 12 generates the switching signal.

The principle of this operation will be described hereinafter.

The magnetic sensor 19 infers the position of the magnetic pole of the rotor 2. Then, the power transistors 11x are switched according to the position of the magnetic pole of the rotor 2 and a speed command signal outputted from the system (for example, the substrate in the unit).

When voltages at both ends of the overcurrent detection resistor reach a voltage equal to or higher than a fixed voltage, the overcurrent detection unit forcibly turns off the power transistors 11x, thus achieving overcurrent protection. When the overcurrent detection unit receives a signal from the temperature sensing element, the overcurrent detection unit forcibly turns off the power transistors 11x, thus achieving superheat protection.

In Embodiment 1, as described above, the position of the magnetic pole of the rotor magnet 2b is detected by the magnetic sensor 19. However, the configuration is not limited to such a configuration. The position of the magnetic pole of the rotor magnet 2b may be detected by sensorless control. In the sensorless control, the position of the magnetic pole of the rotor magnet 2b is inferred from an electric current that flows through the winding 3c or from the voltage applied to and generated in the winding 3c.

In this sensorless control, signals from a shunt resistor and a current sensor may be amplified by an operational amplifier or the like to detect electric currents. There may also be the case where a comparator is used to generate an interruption signal from this current signal, the interruption signal being inputted into the microcomputer 12 to achieve overcurrent protection. A voltage (for example, 15 V) that drives the gate of the power transistor 11x may differ from a microcomputer power supply voltage (for example, 5 V). Therefore, in such a case, a regulator is used to generate a different power supply from one power supply supplied from the outside. For example, a 15 V power supply is supplied from the outside, and the regulator generates a 5 V power supply. This regulator may be incorporated in the gate drive circuit 11y or the power semiconductor module 11,

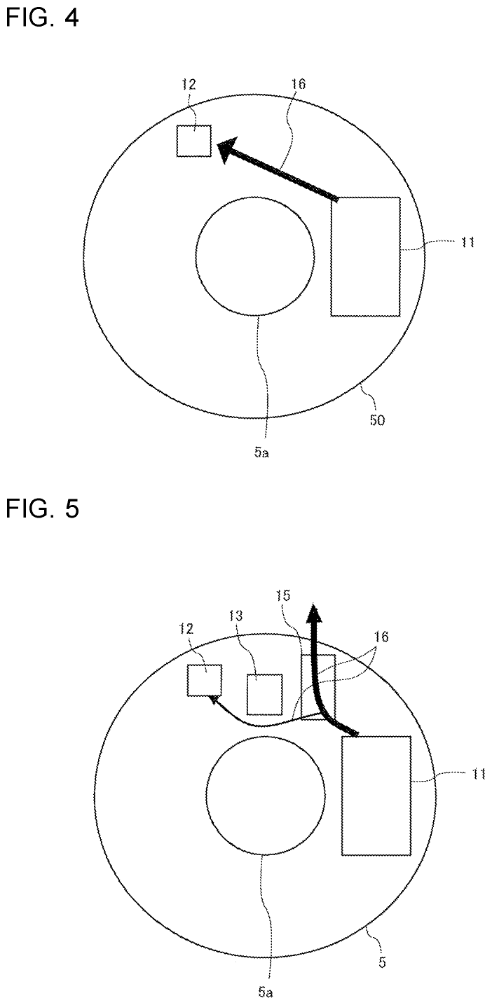

FIG. 3 is a schematic view showing a schematic configuration of the substrate 5 of the power control device 10 included in the electric motor 100 according to Embodiment 1 as viewed from an opposite stator side. FIG. 4 is a first schematic view showing a schematic configuration of a substrate 50 of a power control device included in a conventional electric motor as viewed from an opposite stator side.

As shown in FIG. 3, the power semiconductor module 11 and the microcomputer 12 are mounted on a surface of the substrate 5 on a side opposite to the stator 3 side, Hereinafter, the surface of the substrate 5 on the stator 3 side is referred to as “stator side”, and the surface of the substrate 5 on a side opposite to the stator side is referred to as “opposite stator side”. A first part 13 having a lower thermal conductivity than the molded resin 14 is disposed on the substrate 5 at a position between the power semiconductor module 11 and the microcomputer 12. Examples of the first part 13 include ICs with small power consumption, such as an operational amplifier and a comparator, and a fuse having a cavity therein. The first part 13 is a part having thermal conductivity of equal to or lower than 1 W/mk. The reason the above-mentioned ICs have a low thermal conductivity is that an epoxy resin used as a semiconductor sealing material has a low thermal conductivity. The first part 13 may be formed from a plurality of parts. The position between the power semiconductor module 11 and the microcomputer 12 means a position on the microcomputer 12 side of the power semiconductor module 11 and on the power semiconductor module 11 side of the microcomputer 12. The first part 13 having a lower thermal conductivity than the molded resin 14 is disposed on the substrate 5 at the position between the power semiconductor module 11 and the microcomputer 12 as described above. With such a configuration, compared with a conventional case shown in FIG. 4 where the first part 13 is not disposed on the substrate 5 at a position between the power semiconductor module 11 and the microcomputer 12, the cross-sectional area of paths 16 through which heat is transferred from the power semiconductor module 11 to the microcomputer 12, that is, the cross-sectional area of the molded resin 14 forming the paths 16 through which heat is transferred is reduced, and the length of the paths 16 through which heat is transferred from the power semiconductor module 11 to the microcomputer 12 increases. Therefore, heat is prevented from being easily transferred from the power semiconductor module 11 to the microcomputer 12. Accordingly, in Embodiment 1, it is possible to suppress an increase in temperature of the microcomputer 12 compared with the conventional technique.

The microcomputer 12 is disposed on the surface of the substrate 5 on the opposite stator side and hence, heat from the winding 3c is prevented from being easily transferred to the microcomputer 12. Accordingly, it is possible to further suppress an increase in temperature of the microcomputer 12.

FIG. 5 is a schematic view showing a schematic configuration of a first modification of the substrate 5 of the power control device 10 included in the electric motor 100 according to Embodiment 1 as viewed from the opposite stator side.

Unlike a dedicated IC, such as an application specific integrated circuit (ASIC) or an application specific standard product (ASSP), the microcomputer 12 has a large circuit scale and high clock frequency, and is operated at high speed. Accordingly, it is difficult to increase a guarantee temperature of the microcomputer 12, and costs increase. For this reason, the maximum operation guarantee temperature of the microcomputer 12 is lower than the maximum operation guarantee temperature of the dedicated IC. For example, the maximum operation guarantee temperature of the dedicated IC is 115 degrees C. In contrast, the maximum operation guarantee temperature of the microcomputer 12 is 85 degrees C. Such a difference becomes more significant when a flash memory that requires a special process is incorporated. In the case of a configuration where the substrate 5 is integrally molded by using the molded resin 14, heat from the power semiconductor module 11 and heat from the winding 3c are easily transferred to the microcomputer 12 and hence, the temperature of the microcomputer 12 significantly increases.

In view of the above, as shown in FIG. 5, on the surface of the substrate 5 on the opposite stator side, a second part 15 having a higher thermal conductivity than the molded resin 14 is disposed at a position between the first part 13 and the power semiconductor module 11 and dose to the outer periphery of the substrate 5. The position close to the outer periphery of the substrate 5 means a position that is closer to the outer periphery than to the inner periphery of the substrate 5. The position between the first part 13 and the power semiconductor module 11 means a position on the power semiconductor module 11 side of the first part 13 and on the first part 13 side of the power semiconductor module 11. Examples of the second part 15 include ICs with large power consumption, such as the regulator and the power semiconductor module 11, the resistor, and the capacitor. The second part 15 is a part having thermal conductivity of equal to or higher than 3 W/mk. The reason the above-mentioned ICs have a high thermal conductivity is that a substance having a high thermal conductivity is mixed into an epoxy resin used as a semiconductor sealing material. The second part 15 may be formed from a plurality of parts. On the surface of the substrate 5 on the opposite stator side, the second part 15 is disposed at the position between the first part 13 and the power semiconductor module 11 and close to the outer periphery of the substrate 5 as described above. With such a configuration, heat from the power semiconductor module 11 escapes to the outside of the motor from the outer peripheral side of the substrate 5 via the second part 15 having a higher thermal conductivity than the molded resin 14 and hence, the amount of heat transferred to the microcomputer 12 reduces. Accordingly, it is possible to suppress an increase in temperature of the microcomputer 12.

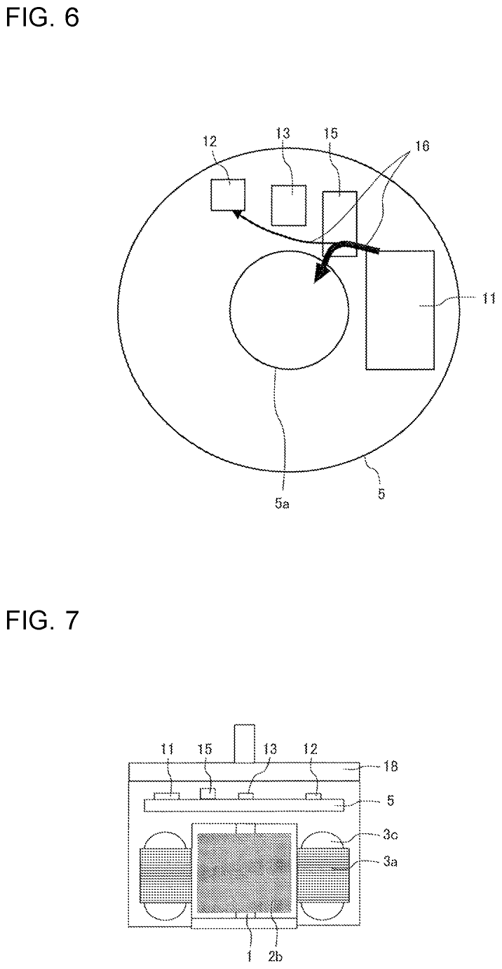

FIG. 6 is a schematic view showing a schematic configuration of a second modification of the substrate 5 of the power control device 10 included in the electric motor 100 according to Embodiment 1 as viewed from the opposite stator side.

As shown in FIG. 6, on the surface of the substrate 5 on the opposite stator side, the second part 15 is disposed at a position between the first part 13 and the power semiconductor module 11 and dose to the inner periphery of the substrate 5. The position dose to the inner periphery of the substrate 5 means a position closer to the inner periphery than to the outer periphery of the substrate 5. With such a configuration, heat from the power semiconductor module 11 escapes to the outside of the motor from the inner peripheral side of the substrate 5 via the second part 15 having a higher thermal conductivity than the molded resin 14 and hence, the amount of heat transferred to the microcomputer 12 reduces. Accordingly, it is possible to suppress an increase in temperature of the microcomputer 12. That is, it is possible to obtain advantageous effects substantially equal to the above-mentioned advantageous effects. The second part 15 may be formed from a plurality of parts.

FIG. 7 is a schematic view showing a cross section of a schematic configuration of the electric motor 100 according to Embodiment 1.

As shown in FIG. 7, a heat sink 18 is disposed on the opposite stator side at a position that faces the substrate 5, and the second part 15 is disposed on the surface of the substrate 5 on the opposite stator side at the position between the power semiconductor module 11 and the first part 13. With such a configuration, heat easily escapes through the path from the first part 13 to the heat sink 18 the first part 13 having a lower thermal conductivity than the molded resin 14. Accordingly, heat is further prevented from being easily transferred to the microcomputer 12. In this case, it is not necessary to dispose the second part 15, having a higher thermal conductivity than the molded resin 14, at a position close to the outer periphery or the inner periphery of the substrate 5,

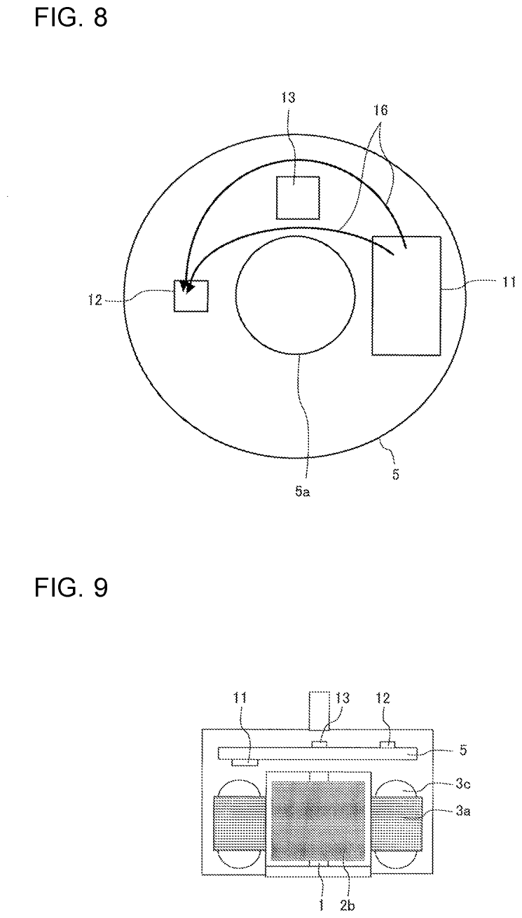

FIG. 8 is a second schematic view showing a schematic configuration of a third modification of the substrate 5 of the power control device 10 included in the electric motor 100 according to Embodiment 1 as viewed from the opposite stator side.

On the surface of the substrate 5 on the opposite stator side, the paths 16 through which heat is transferred are formed between the power semiconductor module 11 and the microcomputer 12. As shown in FIG. 8, in the case where the substrate 5 has the through hole 5a, thus having a toroidal shape, the first part 13 is not always necessary to be disposed on the straight line connecting the power semiconductor module 11 and the microcomputer 12. In the same manner, the second part 15 is not always necessary to be disposed on the straight line connecting the power semiconductor module 11 and the microcomputer 12. Further, a plurality of paths 16 through which heat is transferred may be formed, or only a single path 16 may be formed.

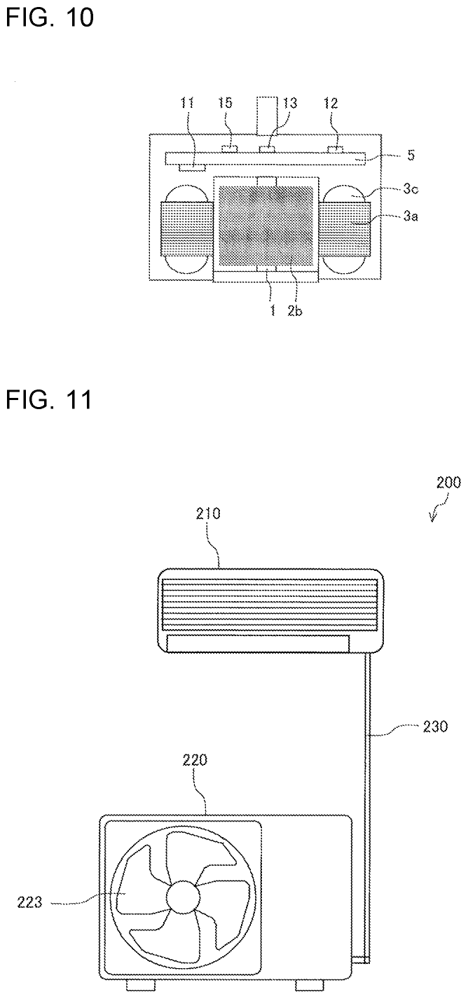

FIG. 9 is a schematic view showing a cross section of a schematic configuration of a first modification of the electric motor 100 according to Embodiment 1. FIG. 10 is a schematic view showing a cross section of a schematic configuration of a second modification of the electric motor 100 according to Embodiment 1.

As shown in FIG. 9 and FIG. 10, regarding the surface of the substrate 5 on which components are disposed, it is not always necessary to dispose the power semiconductor module 11, the microcomputer 12, the first part 13, and the second part 15 on the same surface (on the stator side or the opposite stator side). In the case where the power semiconductor module 11 and the microcomputer 12 are respectively disposed on different surfaces of the substrate 5, either the power semiconductor module 11 or the microcomputer 12 is assumed to be disposed at a plane symmetric position relative to the substrate 5, and the position between the power semiconductor module 11 and the microcomputer 12 includes a position between the plane symmetric position of one of the power semiconductor module 11 and the microcomputer 12 and the other of the power semiconductor module 11 and the microcomputer 12. For example, in the case where the power semiconductor module 11 is disposed on the surface of the substrate 5 on the stator side and the microcomputer 12 is disposed on the surface of the substrate 5 on the opposite stator side, the position between the power semiconductor module 11 and the microcomputer 12 means a position between the plane symmetric position of the power semiconductor module 11 relative to the substrate 5 and the microcomputer 12 on the surface of the substrate 5 on the opposite stator side and a position between the power semiconductor module 11 and the plane symmetric position of the microcomputer 12 relative to the substrate 5 on the surface of the substrate 5 on the stator side. The same applies for a position between the first part 13 having a low thermal conductivity and the power semiconductor module 11.

As described above, the power control device 10 according to Embodiment 1 is the power control device 10 that drives the electric motor 100 including the rotor 2 and the stator 3, the rotary shaft 1 being inserted into the rotor 2, the stator 3 being provided on the outer peripheral side of the rotor 2. The power control device 10 includes: the annular substrate 5 having the through hole 5a and disposed to face the rotor 2 and the stator 3, the rotary shaft 1 being caused to pass through the through hole 5a; the power semiconductor module 11 mounted on the substrate 5 and including the drive circuit 110; and the microcomputer 12 mounted on the substrate 5 and configured to control power supplied to the electric motor 100. The substrate 5 is integrally formed with the stator 3 by using the molded resin 14, and the first part 13 having a lower thermal conductivity than the molded resin 14 is disposed on the substrate 5 at a position between the power semiconductor module 11 and the microcomputer 12. The substrate 5 has an annular shape in Embodiment 1, However, the shape of the substrate 5 is not limited to an annular shape, and the substrate 5 may have other shapes.

In the power control device 10 according to Embodiment 1, the first part 13 having a lower thermal conductivity than the molded resin 14 is disposed on the substrate 5 at a position between the power semiconductor module 11 and the microcomputer 12. Therefore, thermal conductivity is reduced at the position between the power semiconductor module 11 and the microcomputer 12, so that heat from the power semiconductor module 11 is prevented from being easily transferred to the microcomputer 12 and hence, it is possible to suppress an increase in temperature of the microcomputer 12. As a result, it is possible to achieve a higher output and a further reduction in size of the electric motor 100 including the power control device 10.

In the power control device 10 according to Embodiment 1, the second part 15 having a higher thermal conductivity than the molded resin 14 is disposed on the substrate 5 at the position between the power semiconductor module 11 and the first part 13 and close to the outer periphery or the inner periphery of the substrate 5.

With the power control device 10 according to Embodiment 1, it is possible to cause heat from the power semiconductor module 11 to easily escape to the outside of the motor from the inner peripheral side or the outer peripheral side of the substrate 5 via the second part 15 having a high thermal conductivity. Therefore, the amount of heat transferred to the microcomputer 12 is reduced and hence, it is possible to suppress an increase in temperature of the microcomputer 12. As a result, it is possible to achieve a higher output and a further reduction in size of the electric motor 100 including the power control device 10.

In the power control device 10 according to Embodiment 1, the second part 15 having a higher thermal conductivity than the molded resin 14 is disposed on the surface of the substrate 5 on the opposite stator side at the position between the power semiconductor module 11 and the first part 13, and the heat sink 18 is disposed on the opposite stator side at a position that faces the substrate 5.

With the power control device 10 according to Embodiment 1, heat can easily escape through the path from the first part 13 having a low thermal conductivity to the heat sink 18, so that heat is further prevented from being easily transferred to the microcomputer 12 and hence, it is also possible to further suppress an increase in temperature of the microcomputer 12.

In the power control device 10 according to Embodiment 1, the microcomputer 12 is disposed on the surface of the substrate 5 on the opposite stator side.

In the power control device 10 according to Embodiment 1, the microcomputer 12 is disposed on the surface of the substrate 5 on the opposite stator side, so that heat from the winding 3c is prevented from being easily transferred and hence, it is possible to further suppress an increase in temperature of the microcomputer 12.

### Embodiment 2

Hereinafter, Embodiment 2 will be described. The same description as Embodiment 1 will be omitted, and components identical or corresponding to the components in Embodiment 1 are given the same reference symbols.

FIG. 11 is a schematic view showing a constitutional example of an air-conditioning apparatus 200 according to Embodiment 2.

As shown in FIG. 11, the air-conditioning apparatus 200 includes an indoor unit 210 and an outdoor unit 220. The indoor unit 210 is connected with the outdoor unit 220 via a refrigerant pipe 230. The indoor unit 210 includes an indoor unit fan (not shown in the drawing), and the outdoor unit 220 includes an outdoor unit fan 223.

Each of the outdoor unit fan 223 and the indoor unit fan incorporates the electric motor 100 described in Embodiment 1 as a drive source. In Embodiment 2, each of the indoor unit 210 and the outdoor unit 220 includes the fan. However, the configuration is not limited to such a configuration. It is sufficient that at least one of the indoor unit 210 and the outdoor unit 220 include a fan.

The electric motor 100 may be mounted on and used for a ventilation fan, a household electrical appliance, or a machine tool, for example, aside from the air-conditioning apparatus 200. When the maximum output of the motor increases (equal to or higher than 100 W; for example), a large amount of heat is generated from the power semiconductor module 11, so that the large amount of heat is easily transferred also to the microcomputer 12. Accordingly, in such a case, it is possible to obtain a larger effect of suppressing an increase in temperature of the microcomputer 12 described in Embodiment 1.

As described above, the maximum output of the electric motor 100 according to Embodiment 2 is equal to or higher than 100 \N.

In the air-conditioning apparatus 200 according to Embodiment 2; the maximum output of the motor is large, so that a large amount of heat is generated from the power semiconductor module 11. Accordingly, it is possible to obtain a larger effect of suppressing an increase in temperature of the microcomputer 12 described in Embodiment 1.

The air-conditioning apparatus 200 according to Embodiment 2 includes the indoor unit 210 and the outdoor unit 220, at least one of the indoor unit 210 and the outdoor unit 220 includes the fan, and the electric motor 100 is provided as a power source for the fan.

The air-conditioning apparatus 200 according to Embodiment 2 can obtain advantageous effects substantially equal to the advantageous effects of the power control device 10 described in Embodiment 1.

### REFERENCE SIGNS LIST

1: rotary shaft, 2: rotor; 2a: rotor body; 2b: rotor magnet, 2c: sensor magnet, 3: stator, 3a: stator core, 3b: insulator, 3c: winding, 4a: output-side bearing, 4b: opposite-output-side bearing, 5: substrate, 5a: through hole, 6: lead wire, 10: power control device, 11: power semiconductor module, 11R: overcurrent detecting resistor, 11x: power transistor, 11x1 to 11x6: power transistor, 11y: gate drive circuit, 11z: protection circuit, 12: microcomputer, 13: first part, 14: molded resin, 15: second part, 16: path through which heat is transferred, 17: lead-out portion, 18: heat sink, 19: magnetic sensor, 30: molded stator, 31: conductive bracket, 50: substrate, 100: electric motor, 100a motor body, 110: drive circuit, 200: air-conditioning apparatus, 210: indoor unit, 220: outdoor unit, 223: outdoor unit fan, 230: refrigerant pipe.

1. A power control device that drives an electric motor including a rotor into which a rotary shaft is inserted and a stator, the stator being provided on an outer peripheral side of the rotor, the power control device comprising:
a substrate having a through hole and disposed to face the rotor and the stator, the rotary shaft being caused to pass through the through hole;
a power semiconductor module mounted on the substrate and including a drive circuit; and
a microcomputer mounted on the substrate, and configured to control power supplied to the electric motor, wherein
the substrate is integrally formed with the stator by using a molded resin, and
a first part having a lower thermal conductivity than the molded resin is disposed on the substrate at a position between the power semiconductor module and the microcomputer.

2. The power control device of claim 1, wherein
a second part having a higher thermal conductivity than the molded resin is disposed on the substrate at a position between the power semiconductor module and the first part and close to an outer periphery or an inner periphery of the substrate.

3. The power control device of claim 1, wherein
a second part having a higher thermal conductivity than the molded resin is disposed on a surface of the substrate on an opposite stator side at a position between the power semiconductor module and the first part, and
a heat sink is disposed on the opposite stator side at a position that faces the substrate.

4. The power control device of claim 1, wherein the microcomputer is disposed on the surface of the substrate on the opposite stator side.

5. An electric motor comprising:
the rotor into which a rotary shaft is inserted;
the stator provided on an outer peripheral side of the rotor; and
the power control device of claim 1.

6. The electric motor of claim 5, wherein a maximum output is equal to or higher than 100 W.

7. An air-conditioning apparatus comprising:
an indoor unit; and an outdoor unit, wherein
at least one of the indoor unit and the outdoor unit includes a fan, and
the electric motor of claim 5 is provided as a power source for the fan.
